(19) United States
(12) Patent Application Publication
(10) Pub. No.: US 2009/0135686 A1
(43) Pub. Date: May 28, 2009

(54) OFFSET COMPENSATION METHOD FOR LASER POWER CONTROL CIRCUIT

(76) Inventors: Chia-Hsing Hsu, Taoyuan County (TW); Yi-Long Hsiao, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/242,715

(22) Filed: Sep. 30, 2008

(30) Foreign Application Priority Data
Nov. 23, 2007 (TW) 096144696

(51) Int. Cl. G11B 7/00

(52) U.S. Cl. 369/44.32; 369/47.5

(57) ABSTRACT

A method for compensating the offset of a laser power control circuit, which predetermines a fixed reference voltage, adjusts the offset voltage by adding the reference voltage, outputs a summed voltage to a pick-up head, tries to ignite the pick-up head, detects the voltage of the pick-up head, checks whether the detected voltage rises to a specific threshold voltage, continues adjusting the offset voltage if the detected voltage has not risen to the specific threshold voltage and records the offset voltage if the detected voltage has risen to the specific threshold voltage, and configures the offset voltage to be the voltage offset compensation for the laser power control circuit, thereby eliminating feature differences of different pick-up heads of the laser power control circuit.

### BACKGROUND OF THE INVENTION

1. Field of the Invention

The present invention relates to an optical disc drive, and more particularly to a compensation method for the voltage offset caused by the laser power control circuit of the optical disc drive collocating with different pick-up heads.

2. Description of the Prior Art

Optical disc drives employ laser diodes in their pick-up heads as light sources and utilize laser power control circuits to control the pick-up heads, making the laser diodes output laser power steadily, projecting the best laser beams to optical discs in order to read, write, or erase data on the optical discs.

FIG. 1 illustrates a laser power control circuit 10 of a conventional optical disc drive. The laser power control circuit 10 utilizes a servo unit 11 to control and output a voltage. The voltage is then amplified by a gain unit 12 and transmitted to a pick-up head 13, igniting the laser diode 14 in the pick-up head 13 in order to output a laser beam. The pick-up head 13 further comprises a front-monitoring apparatus 15, utilized for constantly monitoring the state of the laser diode 14 and utilized for feeding back the monitoring information to the servo unit 11 in order to adjust and output the proper voltage.

The laser power control circuit and the pick-up head of the optical disc drive often have feature differences resulting from different manufacturing processes, precision and brands. When the laser power control circuit and the pick-up head are assembled in an optical disc drive, adjustment or compensation is necessary for making up for this offset between the laser power control circuit and the pick-up head in order to match the laser power control circuit and the pick-up head. The process mentioned above costs considerable effort and time in fabrication, and also makes the control of the laser power more complicated.

Thus, there are still certain problems in voltage offset compensation for a laser power control circuit in a conventional optical disc drive that need to be resolved.

### SUMMARY OF THE INVENTION

It is therefore one objective of the present invention to provide a voltage offset compensation method for the laser power control circuit. By means of a same reference voltage, voltage offset is adjusted to exceed the barrier voltage of a pick-up head of the laser power control circuit. Different pick-up heads can therefore be ignited, thereby eliminating the feature differences of pick-up heads.

It is another objective of the present invention to provide a voltage offset compensation method for the laser power control circuit, which further employs an offset voltage between the predetermined reference voltage and the barrier voltage of the pick-up head as a voltage offset compensation for the control circuit in order to simplify the control of laser power.

To achieve the foregoing objective, the present invention provides a method, the steps comprising: predetermining a fixed reference voltage, adjusting the offset voltage, adding the offset voltage to the reference voltage, outputting the summed voltage to the pick-up head to try to ignite the pick-up head, detecting the voltage of the pick-up head, checking whether the detected voltage rises to a specific threshold voltage, adjusting the offset output voltage continually if the detected voltage has not risen to the specific threshold voltage or recording the offset voltage at the moment the detected voltage rises to the specific threshold voltage, and finally configuring the offset voltage as a voltage offset compensating for the laser power control circuit. Therefore, the feature differences between different pick-up heads can be eliminated.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of the conventional laser power control circuit.

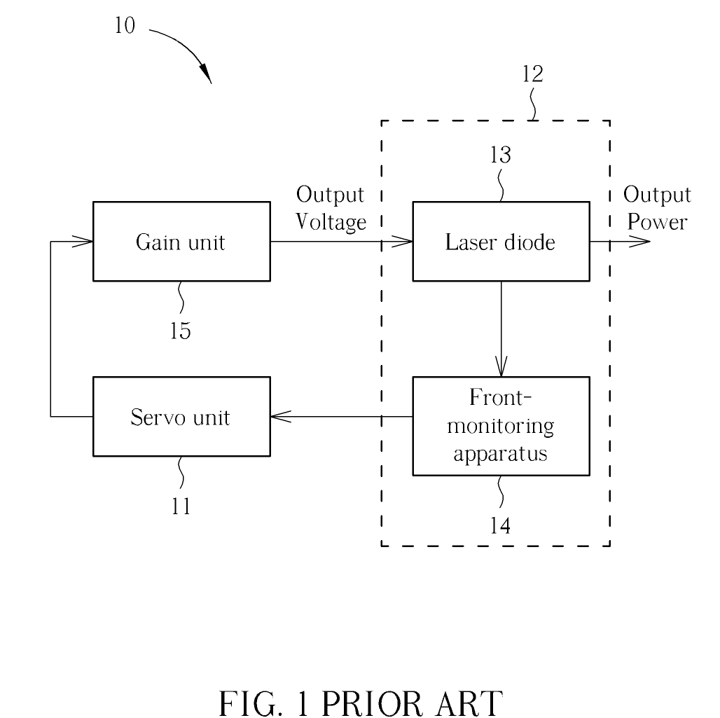

FIG. 2 is a block diagram of the laser power control circuit according to one exemplary embodiment of the present invention.

FIG. 3 is a diagram showing the variation in the voltage of the laser power control circuit according to one exemplary embodiment of the present invention.

FIG. 4 is a flow chart of the laser power control circuit according to one exemplary embodiment of the present invention.

### DETAILED DESCRIPTION

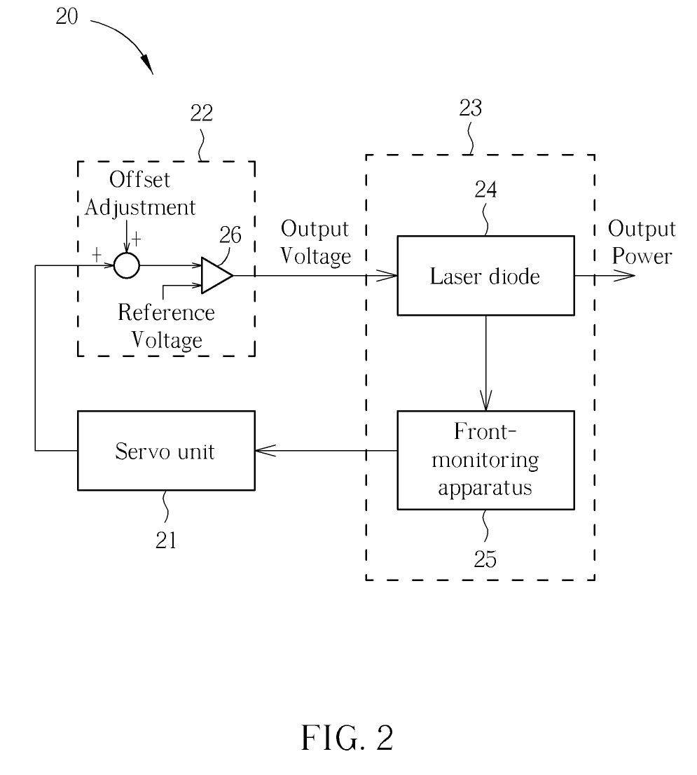

Please refer to FIG. 2, which illustrates a laser power control circuit 20 according to the preferred embodiment of the present invention. The laser power control circuit 20 comprises a servo unit 21, an offset adjustment unit 22, a pick-up head 23, a laser diode 24, and a front-monitoring apparatus 25. The present invention mainly employs a servo unit 21 to control and output a voltage. The voltage is adjusted for voltage offset by the offset adjustment unit 22 and then transmitted to the pick-up head 23 to ignite the laser diode 24 in the pick-up head in order to emit a laser beam. The pick-up head 23 further comprises a front-monitoring unit 25 for monitoring the state of the laser diode 24 at every moment and feeding back the monitoring information to the servo unit 21 to adjust the output voltage in order to output the laser power exactly, wherein a reference voltage is predetermined in the offset adjustment unit 22 of the present invention. The reference voltage can be the standard voltage of the pick-up head 23 or a specific voltage which can ignite the pick-up head 23. The timing regarding the laser power control circuit 20 using the reference voltage can be controlled by the servo unit 21. Usually, the reference voltage starts to be used when the pick-up head is ignited while the reference voltage stops being used at the moment the voltage offset compensation is set.

Utilizing a calculator 26, the reference voltage is increased/decreased with an adjusted offset voltage then transmitted to the laser diode 24 in the pick-up head 23 to emit the laser beam corresponding to the laser power generated by the voltage.

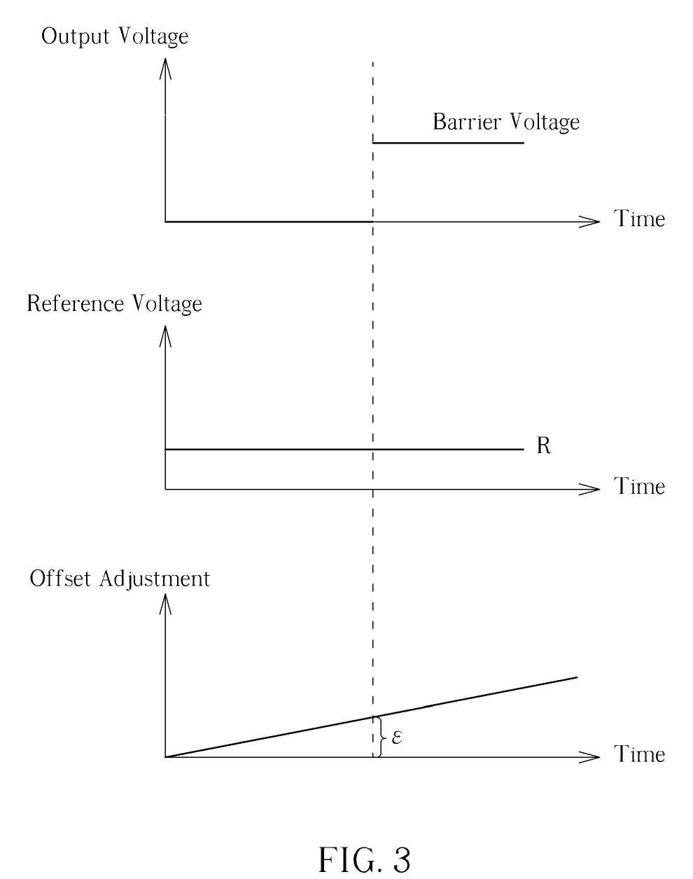

FIG. 3 shows the variation of the voltage regarding igniting the pick-up head 3. Please refer to FIG. 2 and FIG. 3 simultaneously. When turning on the optical disc drive, the laser power control circuit begins outputting a voltage to the pick-up head 23 to ignite the pick-up head 23. Due to a barrier voltage of the pick-up head 23, the voltage outputted to the pick-up head 23 must exceed the barrier voltage in order to enable the pick-up head 23. The front-monitoring apparatus 15 in the pick-up head 23 cannot be activated and provide the monitoring information to the servo unit 21 until the pick-up head 23 is ignited.

The servo unit 21 of the present invention controls and outputs the reference voltage in the initial stage of starting the optical disc drive. For instance, the servo unit 21 outputs a predetermined fixed voltage R as the reference voltage and adjusts the offset voltage by increasing/decreasing it by a fixed amount or a variable amount. In this embodiment, the fixed amount is introduced, wherein the calculator 26 adds the offset voltage to the reference voltage in order to output the summed voltage (the result of adding the offset voltage to the reference voltage) to the pick-up head 23. If the output (summed) voltage does not reach the barrier voltage of the pick-up head 23, the detected voltage will remain at 0 and the servo unit 21 will continually add the reference voltage to the offset output voltage until the pick-up head 23 is ignited. As soon as the output voltage exceeds the barrier voltage of the pick-up head 23, the pick-up head 23 will be immediately ignited from dark to light. Accordingly, the front-monitoring apparatus 15 is activated, and the detected voltage is asserted at once. As the barrier voltages of different pick-up heads 23 are distinct, the output voltage is presumed to reach the barrier voltage of the pick-up head 23 when the output voltage reaches a specific threshold voltage, wherein the specific threshold voltage is configured to be smaller than an average value of the barrier voltages of the pick-up heads 23. The offset voltage E used when the output voltage exceeds the barrier voltage is then recorded, and the offset voltage E can be deemed as the feature differences caused by collocating the laser power control circuit 20 and the pick-up head 23. Therefore, the offset voltage E is directly utilized for the voltage offset compensation regarding the collation of the laser power control circuit 20 and the pick-up head 23 in the optical disc drive.

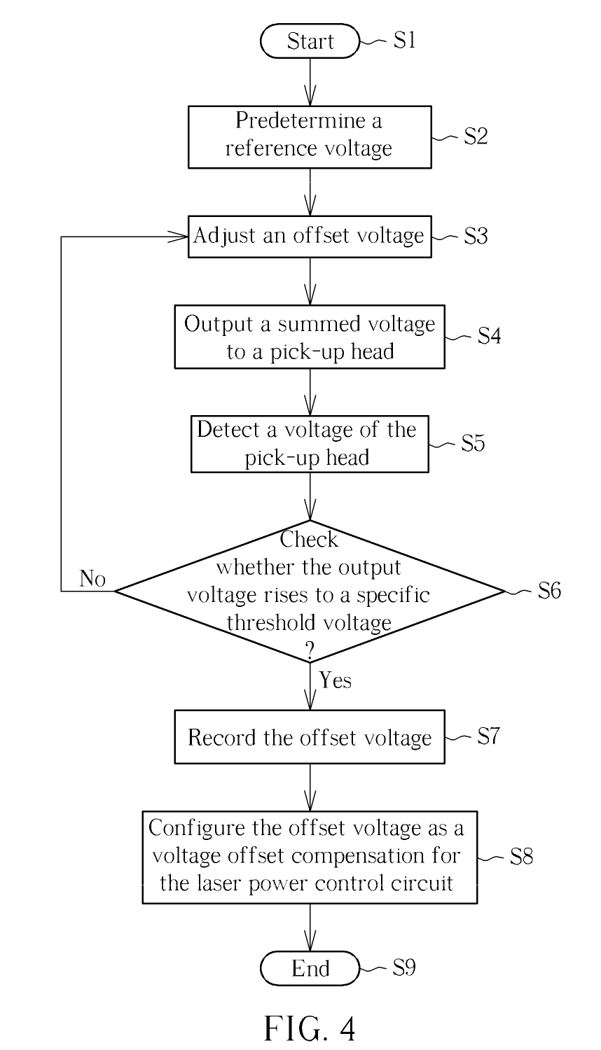

FIG. 4 illustrates a flow chart regarding the method of compensating the voltage offset of the laser power control circuit of the present invention. The present invention employs an offset voltage E used when igniting the pick-up head to compensate the laser power control circuit. The detailed process is explained as follows.

First, the step S1 starts to set up the voltage offset compensation for the laser power control circuit. In the step S2, a reference voltage is predetermined as the reference voltage for igniting the pick-up head. Then, the offset voltage is adjusted, and the offset voltage is added to the reference voltage as the output voltage in step S3. When the process goes to the step S4, the output voltage is sent to the pick-up head for trying to ignite the pick-up head. In the step S5, the voltage feedback is detected by the pick-up head. Then, it is checked whether the detected voltage rises to a specific threshold voltage. If the detected voltage does not reach the specific threshold voltage, the detected voltage will remain at 0, and it will be deemed that the detected voltage does not reach the barrier voltage, in which case the process goes to the step S3 and the offset voltage will be continually adjusted and the output will then be changed. If the detected voltage rises to a specific threshold voltage, the offset voltage used when the detected voltage exceeds the barrier voltage is recorded. In the step S8, the offset voltage is configured as the voltage offset compensation for the laser power control circuit. Finally, the process goes to step S9, to end configuration of the compensation for voltage offset.

According to the offset compensation method for the laser power control circuit mentioned above, the present invention configures a same reference voltage and adjusts the voltage offset by each laser power control circuit, so that when barrier voltages of the pick-up heads are exceeded, a corresponding pick-up head will be ignited. The present invention not only eliminates the feature differences between different pick-up heads but also utilizes the offset voltage between the predetermined reference voltage and the barrier voltage as an offset compensation for a laser power control circuit when the optical disc drive collocates a pick-up head. Therefore, the control of the laser power can be simplified and the time and effort for assembly can also be reduced as a complicated adjustment and compensation procedure is unnecessary under the present invention.

Those skilled in the art will readily observe that numerous modifications and alterations of the device and method may be made while retaining the teachings of the invention.

What is claimed is:

1. An offset compensation method for a laser power control circuit, the method comprising:
(1) predetermining a reference voltage;
(2) adjusting an offset voltage;
(3) adding the offset voltage to the reference voltage to generate a summed voltage, and outputting the summed voltage to a pick-up head to try to ignite the pick-up head;
(4) detecting a voltage of the pick-up head;
(5) checking whether the detected voltage rises to a specific threshold voltage, if yes, going to step (6); otherwise, going back to step (2);
(6) recording the offset voltage used when the detected voltage reaches the specific threshold voltage;
(7) configuring the offset voltage as a voltage offset compensation for the laser power control circuit.

2. The offset compensation method for the laser power control circuit of claim 1, wherein the reference voltage is configured as the voltage capable of igniting the pick-up head.

3. The offset compensation method for the laser power control circuit of claim 1, wherein the reference voltage is a fixed reference voltage.

4. The offset compensation method for the laser power control circuit of claim 1, wherein the reference voltage starts to be used when controlling the laser power control circuit to ignite the pick-up head while the reference voltage stops being used when the offset compensation is set.

5. The offset compensation method for the laser power control circuit of claim 1, wherein the offset voltage is adjusted by increasing/decreasing an offset amount.

6. The offset compensation method for the laser power control circuit of claim 5, wherein the offset amount is fixed.

7. The offset compensation method for the laser power control circuit of claim 5, wherein the offset amount is variable.

8. The offset compensation method for the laser power control circuit of claim 1, wherein the specific threshold voltage is configured to be smaller than an average barrier voltage of the pick-up head.
